(19) United States
(12) Patent Application Publication
(10) Pub. No.: US 2009/0271701 A1
(43) Pub. Date: Oct. 29, 2009

(54) Method for Systematically Identifying Technology-Based Solutions

(75) Inventors: Hans-Juergen Bossmeyer, Germering (DE); Peter Ratz, Herrsching (DE); Michael Reger, Unter-Schleissheim-Hollern (DE); Christian Huber, Freising (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/200,033

(22) Filed: Aug. 28, 2008

Related U.S. Application Data
(63) Continuation-in-part of application No. 12/111,438, filed on Apr. 29, 2008.
Application No. 12/111,438 is a continuation-in-part of application No. 12/111,447, filed on Apr. 29, 2008.
Application No. 12/111,447 is a continuation-in-part of application No. 12/111,471, filed on Apr. 29, 2008.

(51) Int. Cl. G06F 17/30; G06F 3/048

(52) U.S. Cl. 715/700; 707/104.1; 707/E17.009

(57) ABSTRACT

A process for identifying technology-based solutions in the context of technical component development includes identifying technical components for particular technical systems, as well as the corresponding technological functions associated with the identified technical components. In one embodiment, development obstacles associated with technical component development may be identified. A set of potential solutions corresponding to the identified obstacles may then be generated using prior project information and/or the information accessed from one or more technology databases.

### CROSS REFERENCE TO RELATED APPLICATIONS

This application is a continuation-in-part of U.S. application Ser. No. 12/111,438, filed on Apr. 29, 2008 and entitled SYSTEM AND METHOD FOR PROVIDING AND MANAGING TECHNOLOGY-BASED INFORMATION; and is also a continuation-in-part of U.S. application Ser. No. 12/111,447, filed on Apr. 29, 2008 and entitled SYSTEM AND METHOD FOR UTILIZING TECHNOLOGY INTERCONNECTIVITIES; and is also a continuation-in-part of U.S. application Ser. No. 12/111,471, filed on Apr. 29, 2008 and entitled SYSTEM AND METHOD FOR UTILIZING ORGANIZATION-LEVEL TECHNOLOGY DEMAND INFORMATION.

### FIELD OF THE INVENTION

The present invention relates in general to technology-based solutions, and more particularly to a novel methodology for systematically identifying technical solutions in a technology development environment.

### BACKGROUND OF THE INVENTION

It is a well known fact that the present-day technical project landscape is characterized by extreme diversity and high developing rates. In order to keep up with such a dynamic environment, development teams must learn to deal better with both the increasing complexity of the underlying technical systems as well as the high development rates in the area of new technologies.

Technology development tends to be a fragmented and inefficient process, particularly when the underlying product is composed of many different and distinct technologies. The field of vehicle manufacturing is one example where there tends to be many different ongoing development efforts across numerous different technological areas. These efforts are typically engaged in by different development teams with little or no contact between each other, despite the fact that their efforts may overlap from time to time. Moreover, there is currently no systematic approach for addressing and identifying potential technology-based solutions to the various technological obstacles which tend to arise during such development efforts.

### BRIEF SUMMARY OF THE INVENTION

Disclosed and claimed herein are methods for systematically identifying technical solutions in a technology development environment. In one embodiment, a method for identifying technology-based solutions includes identifying a plurality of technical components for each of a plurality of technical systems, and identifying technological functions associated with at least one of the plurality of technical components. The method also includes identifying, using at least in part the identified technological functions, obstacles associated with technical component development. A technology database may also be accessed using at least one of the identified obstacles and identified technological functions. The method further includes accessing prior project information, and then generating a set of potential solutions for the identified obstacles based on the prior project information and information from the technology database.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a simplified system diagram as may be employed by one or more embodiments;

FIGS. 2A-2H depict various graphical user interfaces for implementing one or more aspects of the invention;

FIG. 3 depicts a flow diagram for one embodiment of a process for carrying out one or more aspects of the invention;

FIG. 4 depicts a flow diagram for another embodiment of a process for carrying out one or more aspects of the invention;

FIG. 5 depicts a flow diagram for still another embodiment of a process for carrying out one or more aspects of the invention;

FIG. 6 is one embodiment of a user interface usable with the invention;

FIG. 7 is a diagram depicting the interaction between one or more technology databases and the user interface of FIG. 6, according to one embodiment;

FIG. 8 is a user interface configured in accordance with another embodiment of the invention;

FIG. 9 is a relational block diagram depicting the interaction between various components, in accordance with the principles of the invention; and

FIG. 10 is a flow diagram for one embodiment of a process for carrying out one or more aspects of the invention.

### DETAILED DESCRIPTION OF EXEMPLARY EMBODIMENTS

### Overview of the Disclosure

The present disclosure relates generally to the concept of systematically identifying technical solutions in a technology development environment. One aspect of the invention relates to break down a set or category of technical systems into their individual technical components, and then to further identify the underlying technological layer to those technical components. In certain embodiments, the technological layer may include the principles or technological functions underlying the technical components, any existing hindrances or obstacles in the development of such components. In addition, the technological layer may further identify the physical effect created or invoked by the various technical components.

In certain embodiments, the technological layer may be populated (either manually or automatically) using a technology database that is based on and organized according to a set of optimized technology profiles and their relationships to one another. As fully disclosed below, a predetermined set of technology attributes may be defined, where such technology attributes correspond to a set of predetermined traits that, when defined, may encompass everything from the basic description of a subtechnology to the intricate channels through which the world affects it, and it affects the world. In one embodiment, a plurality of subtechnologies may then be identified, wherein each of the plurality of subtechologies may be characterized by a common granularity level. Once this plurality of subtechnologies have been properly identified a corresponding plurality of subtechnology profiles may be generated. In one embodiment, these subtechnology profiles may be generated based on the previously-defined set of technology attributes. In one embodiment, the generated subtechnology profiles may then be stored in a common technology database, and then used to populate the aforementioned technological layer.

Another aspect of the invention is to generate a set of potential solutions corresponding to the identified obstacles using prior project information and/or the information accessed from a technology database. In one embodiment, the generated set of potential solutions may include spontaneous solutions, solutions based on interconnections with other projects and/or solutions based on interconnections with other technologies. In one embodiment, the set of potential solutions may be provided to a user in the form of a solution staging area which may simultaneously display all three potential solutions sets—spontaneous solution suggestions, other project interconnections and other technology interconnections.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, A, B or C means any of the following: A; B; C; A and B; A and C; B and C; A, B and C. An exception to this definition will occur only when a combination of elements, functions, steps or acts are in some way inherently mutually exclusive. Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, a fiber optic medium, etc.

### The Concept of Subtechnogies

As used herein, the term “considered technology” refers to any technology being considered by a project that can be broken down into various broad, but fundamental working systems. The term “proper technology” is any technology that represents the physical implementation of one of a considered technology's fundamental working systems. In addition, a “technological function” is any scientifically based purpose that is necessary for the proper or desired operational effect of a fundamental component of a proper technology.

A “physical effect” describes the scientific mechanism or process behind the characteristic effects resulting from, or used as a basis for the normal operation of a subtechnology that allows it to fulfill a technological function.

In addition, a “technology family” is a group of technologies that are related in a way where they all fall under a common theme, but where the theme is so broad that the technologies cannot be considered as any type of proper or improper variant of one another. Note: a technology field is any group of technology families related in a similar fashion.

In its broadest sense, a “subtechnology” is an area of a field of technology having a granularity between that of a technology family and a physical effect. A subtechnology may refer to a technology component of a proper technology that provides a way to fulfill a technological function of that proper technology, and which also exhibits a set of common characteristics. In one embodiment, the common characteristics of a subtechnology may be that:
it's variants should not ‘proliferate to excess’;
it should be a physical representation of one or more specific physical effects, and not a physical effect itself;
it should be less granular than a technology family; and
it should not be a product itself, rather it can be the working principle behind a product.

With reference to the term “proliferate to excess,” if a technology has either so many proper variants that it becomes practical to call them all different technologies instead of variants of one technology, or the technology has one or more improper variants, then it may be said that the technological concept has variants that ‘proliferate to excess.’

A proper variant is any modified version of something that fulfills the same purposes, but that does not differ so much from the original entity that it becomes more useful or practical to consider the modified version as unique in itself rather than a variant of the original entity. In contrast, an improper variant is any modified version of something that does not fit the description of a proper variant.

The concept of what a subtechnology is is rooted in understanding that technologies can be divided into levels of granularity. In short, in order to profile a subtechnology, one must first determine the optimal granularity level for a technological area. For example, a subtechnology profile of a sport utility vehicle is less likely to be helpful to an innovation engineer than a profile for organic light-emitting diodes. Thus, technologies may be filtered into those that aptly reflect this optimal complexity level and focus on their functional contribution or utilization. This may have the further benefit of reducing the technological complexities caused by interconnectivity identification since there is a focus on the functionality of the underlying subtechnology and not the application thereof.

As previously mentioned, a subtechnology may be said to have a granularity between that of a technology family and a physical effect (such as electroluminescence). When using the concept of a physical effect in conjunction with the process of creating a technology profile, the subtechnology's attributes (described below) can be used as a signal to help identify unfavorably granular technologies. It should also be noted, however, that the field/family structure may be only semi-permanent, meaning that as the technological landscape changes and new fields or families emerge, the structure may change as well.

In one embodiment, this granular filtering of technology into subtechnologies may be achieved by systematically applying a set of guidelines and refinement routines to a technological concept until either a suitable or optimal subtechnology profile is achieved, or the technological concept is deemed outside the optimal complexity level and thus excluded from the database. These predetermined guidelines and refinement routines may be referred to as profile creation procedures, and may further include a description of what type of information should be entered into the individual attributes, how the information should be recorded, and documentation on where in the field/family structure for the subtechnology is organized.

Subtechnologies having unfavorable granularities may be classified umbrella technologies, product engineering technologies, and exceedingly granular technologies. Umbrella technologies, such as energy harvesting, are technologies that fit the pragmatic definition of subtechnology, but that are more of a collection of individual, more optimal subtechnologies. Product engineering technologies, such as combustion engines, are those that represent the engineering behind a specific product rather than the technique behind a subtechnology. A better example would be hydrogen combustion, which has application in combustion engines, but represents the technique behind the combustion and not just combustion itself. Exceedingly granular technologies, such as electroluminescence, are technologies that exist more optimally as an attribute (here, a physical effect) of a subtechnology rather than as a stand-alone subtechnology. Proper definition of the attributes for a considered technology should effectively filter out the more optimal granularities, and the profile creation procedure is designed around this.

By way of example, consider the electric drivetrain of a battery electric vehicle. Proper technologies may include the battery system, transmission or drivetrain, and drive dynamic control systems. The components of the battery system may include the battery itself (various types), the battery operation management system, and the battery energy management system (cooling, insulating). Similarly, the components of drive dynamic control systems may include the brake system (energy harvesting potential for charging battery or powering supplementary systems such as air conditioner or stereo), suspension system (same energy harvesting potential), driver feedback systems (dashboard gauges, throttle controls, power steering, etc.), and the automated traction control systems (ABS, 4WD, AWD, ESP, etc.).

With the proper technologies identified, again by way of example only, we may consider whether energy harvesting is a true or relevant subtechnology. First, we identify a common granularity level for our subtechnologies and, once determined, apply the same of criteria across our set of proper technologies. This common granularity may be determined by answering the following questions, although it should of course be appreciated that other criteria may be used in defining the granularity level and/or determining a relevant subtechnology:
Can it be a technological component of a proper technology?
Can it fulfill a technological function of a proper technology?
It's variants don't proliferate to excess (green means they don't)?
Is it a physical representation of greater than a physical effect?
Is it less granular than a technology family?
It's not a product, rather it can be a working principle behind a product?

In this example, we are considering energy harvesting, which is the process by which energy is captured and stored for further use. With respect to the first question set forth above, we see that it cannot be a physical component of a proper technology, because by definition it is a process, not a physical thing. With respect to the second question, while energy harvesting can be the technological function of a proper technology, the abstract idea of energy harvesting itself is not a physical component that can accomplish it. For the third question, energy harvesting can be many different unique technologies (water turbine, running shoe, knee implant, etc.). For the fourth question, energy harvesting does not fit the definition of a physical effect because it is the characteristic effect related to the normal operation of a subtechnology, not an explanation of the scientific mechanism or process behind it. For the fifth question, energy harvesting is less granular than a technology family, because all of its variants have such a similar working purpose. And finally, energy harvesting is not a product, but can be the working principle behind one. Since we were not able to answer all of the criteria in the affirmative, energy harvesting would not be a subtechnology under our chosen criteria.

Another example is piezoelectronic damping systems, which are electrical systems that utilize the piezoelectric effect of a material to generate electricity that regulates an actuator for the purpose of damping the motion of that material. We answer the granularity questions chosen for this example as follows:
Question 1: It could be a component of an intelligent suspension system.
Question 2: It could help with variable shock absorption.
Question 3: It does not have myriad variants, just scaled variants, and variants on the type of piezoelectric material used.
Question 4: It is a physical representation of the piezoelectric effect in use.
Question 5: It is less granular than a technology family.
Question 6: It is not a product itself, but it can be used as a basis for one.

Based on affirmative answers to each of the above questions, we can conclude that piezoelectronic damping system is a subtechnology. Again, it should be noted that the specific criteria used to define the common granularity level and hence, when something is a subtechnology, may vary, and the criteria applied herein to define the granularity level should not be limiting.

One final example is H2-combustion, which is the exothermic chemical reaction between hydrogen and oxygen that produces water vapor and energy. We may answer the granularity questions chosen for this example as follows:
Question 1: It can be a technological component of an engine or motor.
Question 2: One technological function of an engine or motor is to convert chemical bond energy, and H2-Combustion certainly does that.
Question 3: The only real variants are if you add fuel aggregates into the mixture, but those do not seem to proliferate to excess.
Question 4: Combustibility fits the description of a physical effect, and H2-Combustion is a physical representation of it.
Question 5: It is less granular than a technological family.
Question 6: It is not a product, but it can be used as a basis for an H2-Combustion based product.

Based on affirmative answers to each of the above questions, we can conclude that H2-combustion is also a valid subtechnology according to the chosen criteria applied for the granularity level of this example.

Table 1 below summarizes the results of the above-described examples, as well as a few additional examples.

TABLE 1
Summary of Possible Subtechnologies

| | | | | | | | | Tesla | |
|---|---|---|---|---|---|---|---|---|---|
| | | | Piezoelectronic | | H2- | | Li-Ion | Roadster | |
| | | Energy | Damping | H2- | Combustion | Polymer | Polymer | Battery | Energy |
| | | Harvesting | Systems | Combustion | Motor | Batteries | Batteries | System | Management |
| i | Can it be a technological component | N | Y | Y | N | Y | Y | N | N |
| | of a proper technology? | | | | | | | | |
| ii | Can it fulfill a technological function | N | Y | Y | N | Y | Y | N | N |
| | of a proper technology? | | | | | | | | |
| iii | It's variants don't proliferate to | N | Y | Y | Y | N | Y | Y | N |
| | excess (green means they don't)? | | | | | | | | |
| iv | Is it a physical representation of | N | Y | Y | Y | Y | Y | Y | N |
| | ≧1 physical effect, and not | | | | | | | | |
| | one itself? | | | | | | | | |
| v | Is it less granular than a technology | Y | Y | Y | Y | Y | Y | Y | N |
| | family? | | | | | | | | |
| vi | It's not a product, rather it can be a | Y | Y | Y | Y | Y | Y | N | Y |
| | working principle behind a product? | | | | | | | | |
| vii | Therefore is it a relevant | N | Y | Y | N | N | Y | N | N |
| | subtechnology? | | | | | | | | |

### Exemplary Network Overview

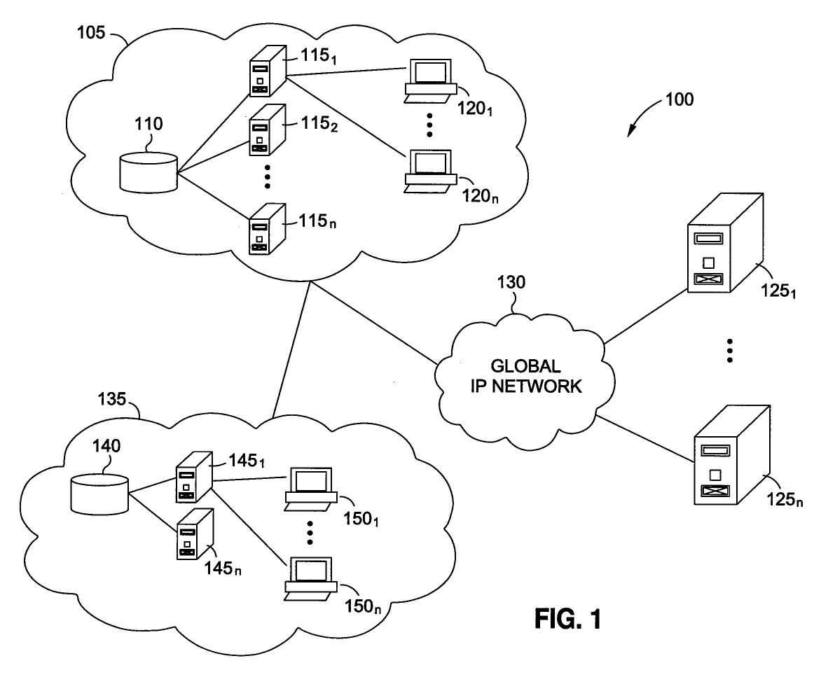

As depicted in FIG. 1, a simplified system diagram is provided for an extended data network 100. As shown, extended network 100 includes an organization-level network 105. While in one embodiment, the organization-level network 105 may correspond to a single company or business, it should equally be appreciated that the organization-level network 105 may relate to other organization levels as well (e.g., country, institution, industry, etc.). Regardless, the organization-level network 105 is comprised of a technology database 110 which, as will be described in detail below, may contain detailed information on a collection of technologies. As shown, the technology database 110 may be accessible through one or more servers 115₁-115ₙ. The servers are, in turn, accessible by one or more work stations 120₁-120ₙ. Alternatively, the technology database 110 may be directly accessible by the work stations 120₁-120ₙ. In certain embodiments, the work stations 120₁-120ₙ may be configured to execute software which generates a graphical user interface (GUI) specially designed to interface with the technology database 110 and to access the underlying information stored therein. In this fashion, individuals associated with the organization (e.g., employees, contractors, etc.) may access the technology database 110 via the database GUI of the work stations 120₁-120ₙ. It should of course be appreciated that the technology database 110 may be a single database or a collection of individual databases.

Continuing to refer to FIG. 1, the organization-level network 105 may optionally be able to access one or more third-party servers 125₁-125ₙ over a global network 130 (e.g., the Internet). Such third-party servers 125₁-125ₙ may correspond to publicly-accessible online information sources, as well as to subscription based sources. In one embodiment, the technology database 110 may be populated with information obtained from the third-party servers 125₁-125ₙ.

The extended network 100 of FIG. 1 further depicts the organization-level network 105 as optionally being able to communicate with an external organization-level network, such as network 135. As with the organization-level network 105, the external organization-level network 135 may correspond to a single company or business, or to any other type of organization (e.g., country, institution, industry, etc.).

The external organization-level network 135 of FIG. 1 also includes a technology database 140 that is accessible through one or more servers 145₁-145ₙ, and in turn, by one or more work stations 150₁-150ₙ. In this fashion, the organization-level network 105 may share information with other organizations, thereby potentially improving the quantity and quality of the information available to, or stored on, the technology database 110.

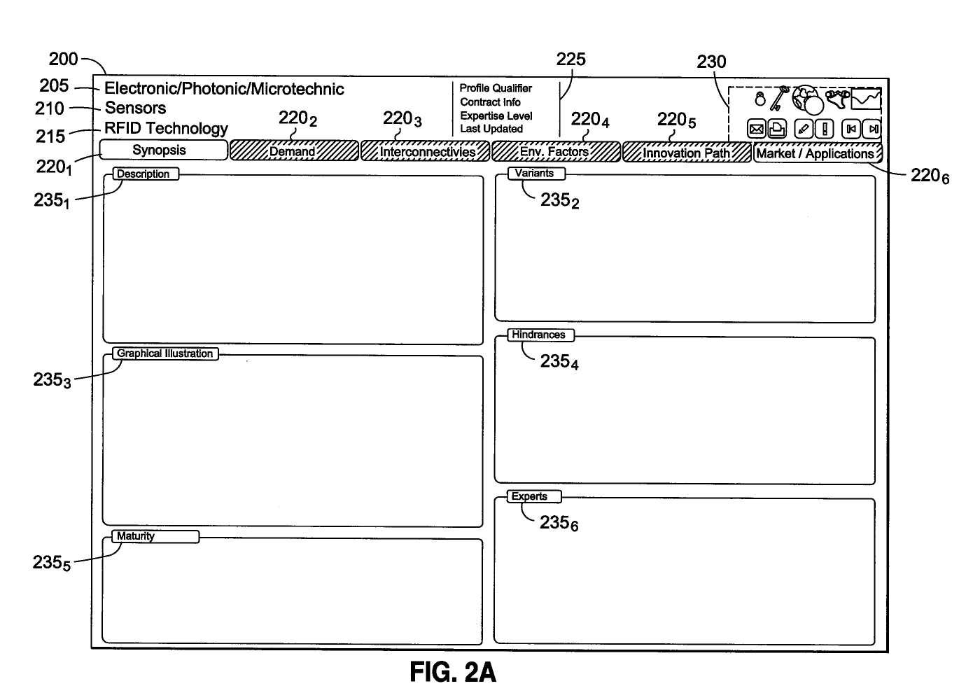

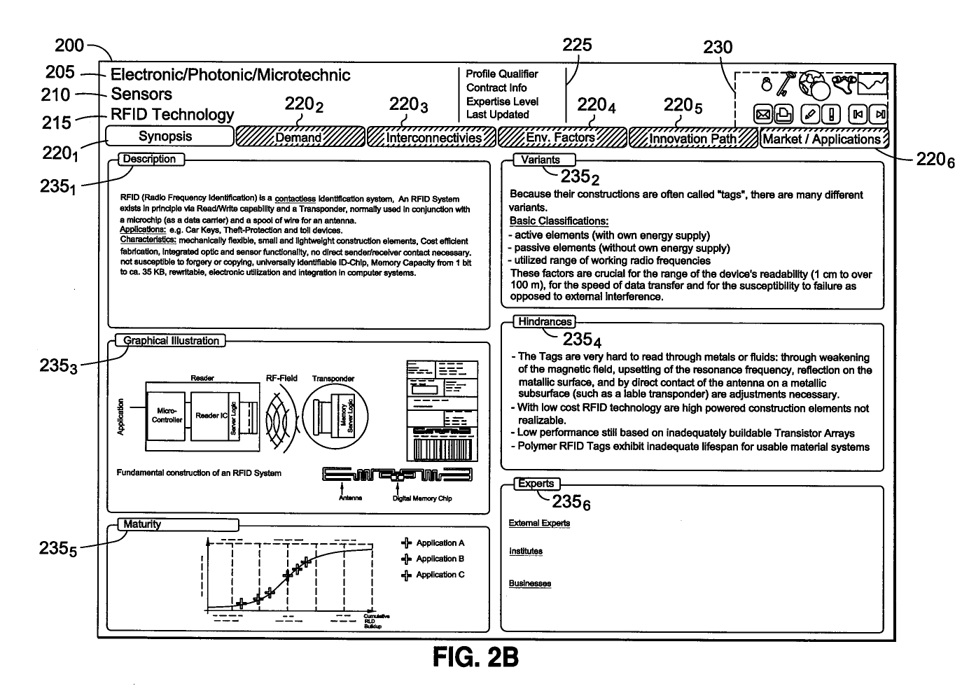

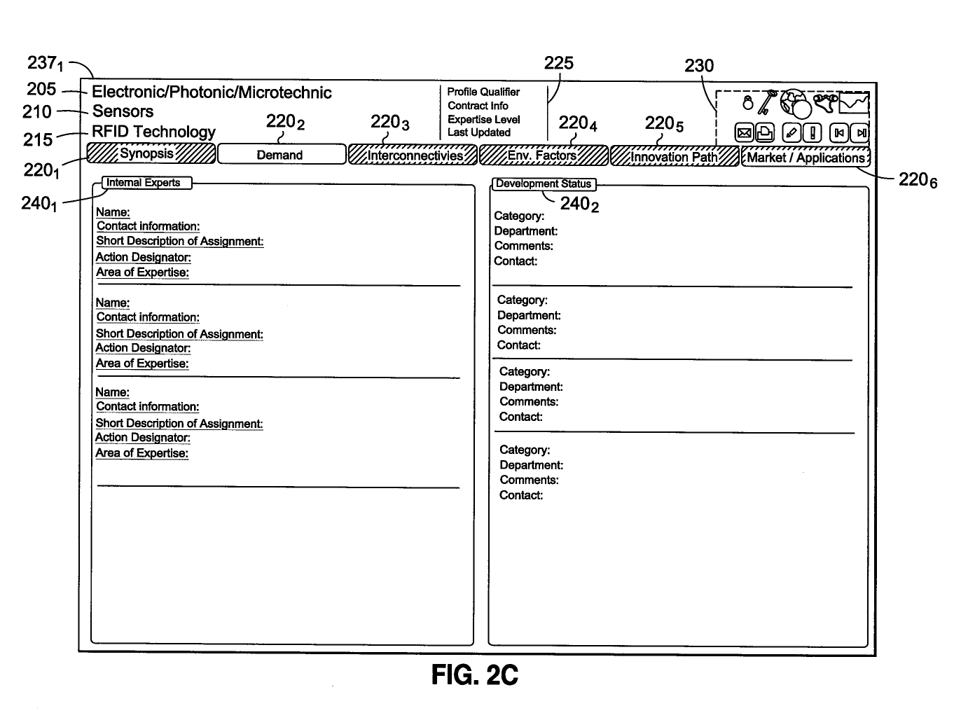

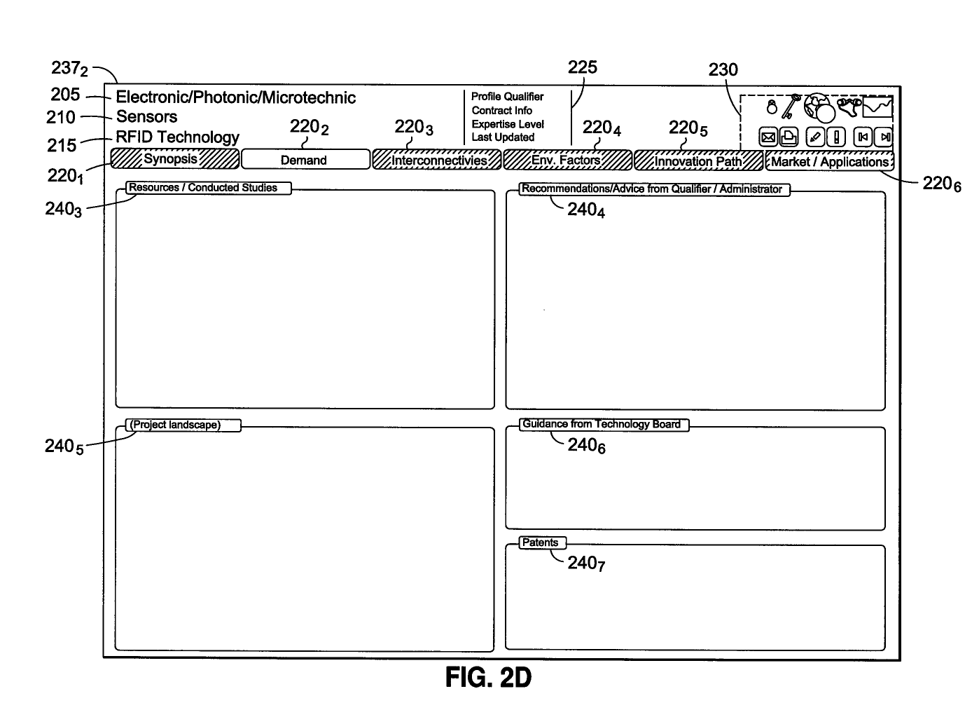

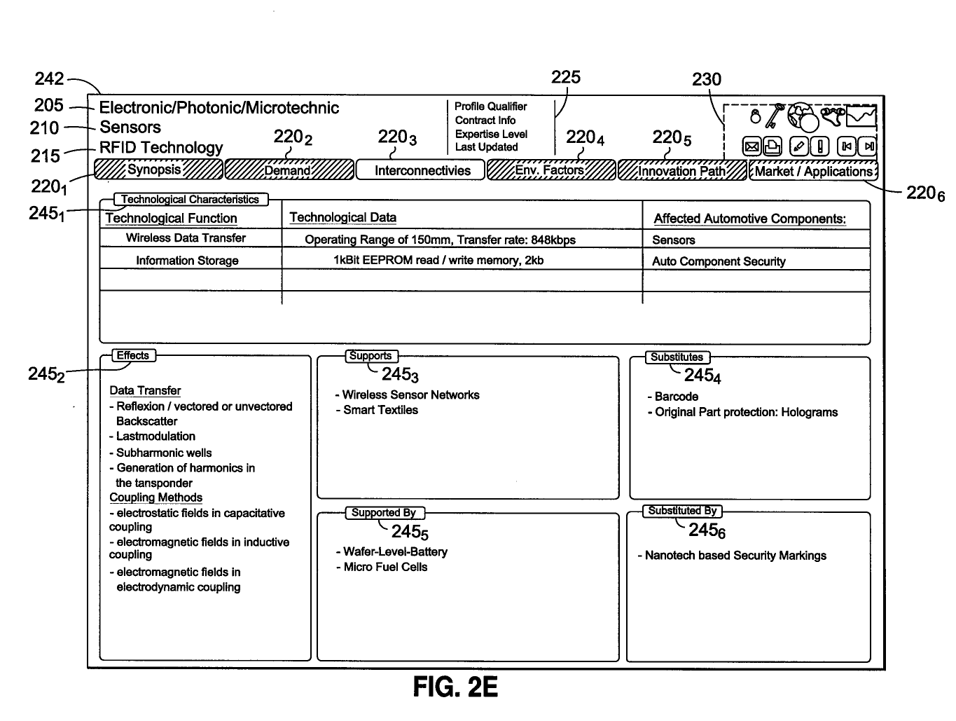

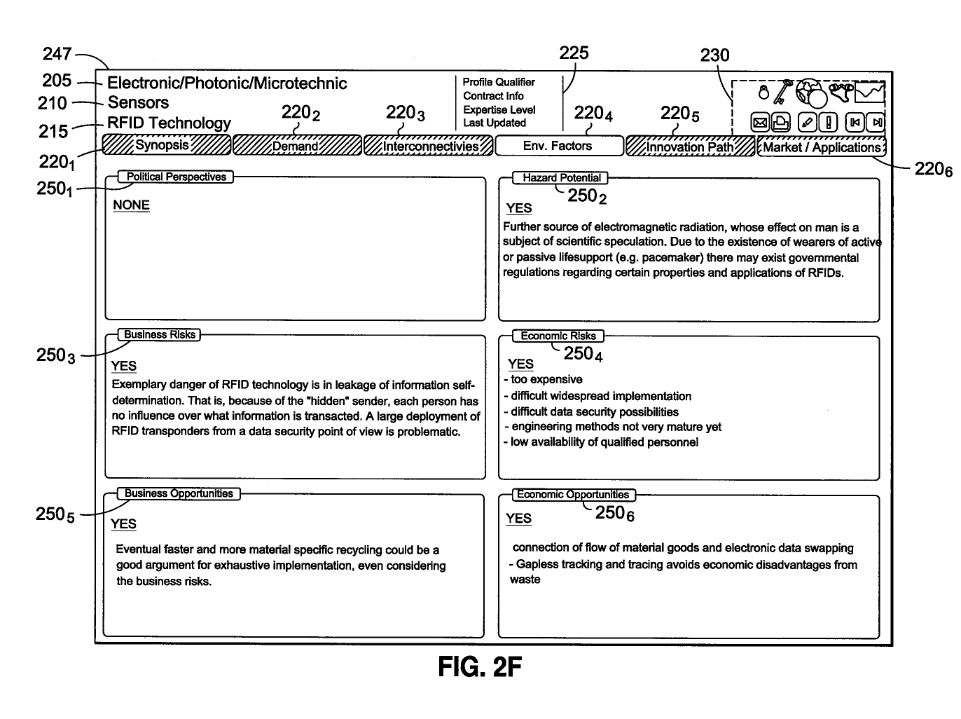

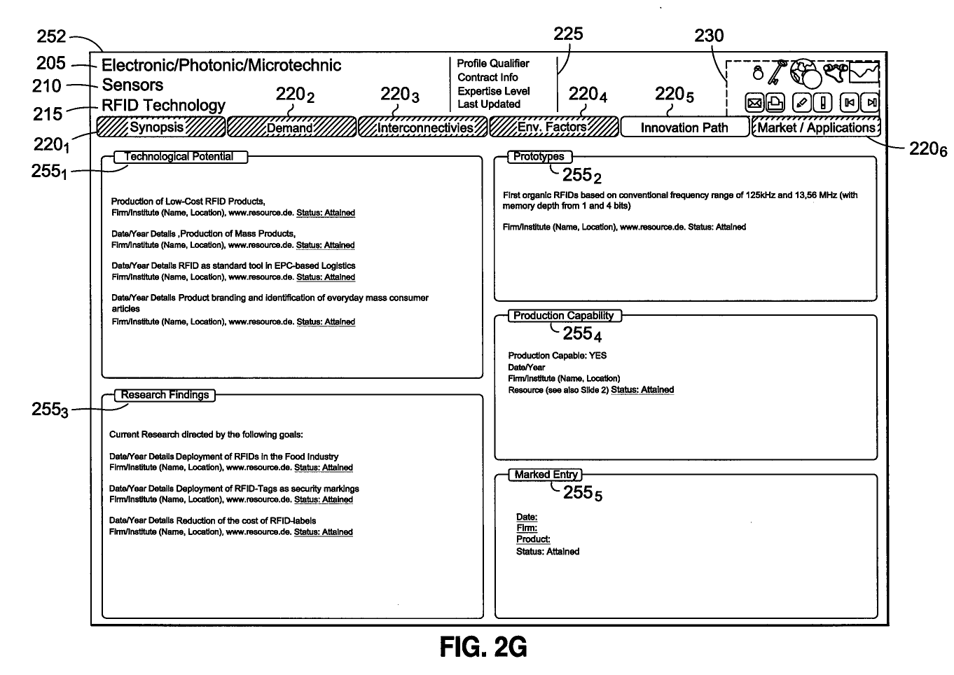

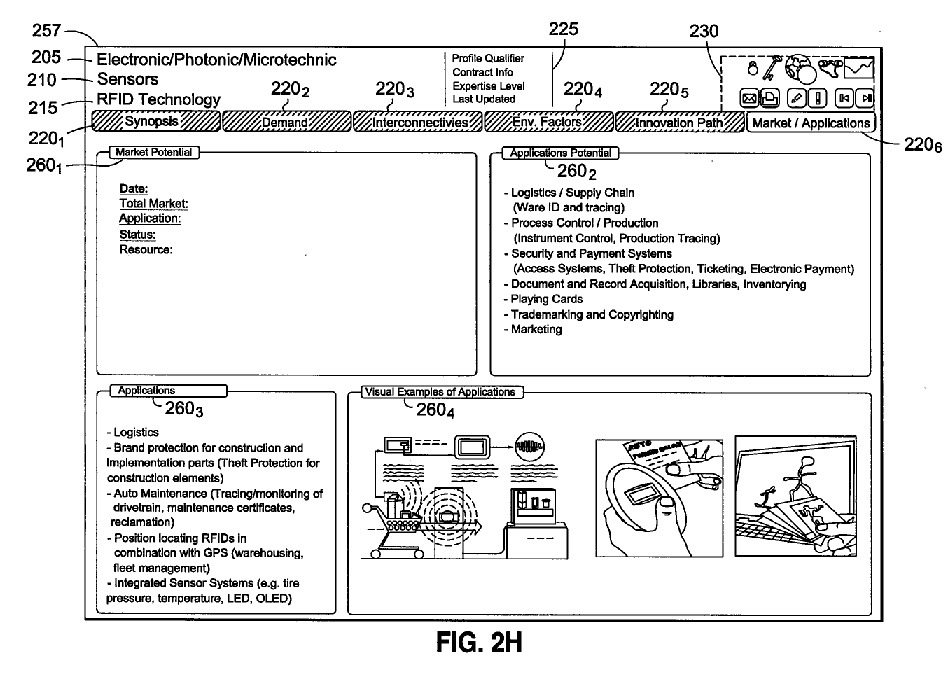

Referring now to FIG. 2A, depicted is one embodiment of a GUI template 200 usable for systematic profiling of subtechnologies. In one embodiment, the GUI template 200 may be accessed from a work station (e.g., work stations 120₁-120ₙ) of an organization-level network (e.g., network 105). The GUI template 200 may be configured to enable a user to profile a given subtechnology into a technology database (e.g., technology database 110) in accordance with a field/family structure.

With respect to the field/family structure, every technology is relevant to a certain field, such as materials, electronics, energy or resources. Such areas are referred to herein as technology fields and their related subcategories as technology families. In the embodiment of FIG. 2A, the technology field 205 is the field of electronic/photonic/microtechnic, while the technology family 210 is sensors. Below the technology family 210 is the subtechnology 215 level. In the embodiment of FIG. 2A, the subtechnology 215 level is radio frequency identification technology, or RFID.

Continuing to refer to FIG. 2A, the GUI template 200 may be further comprised of profile creation logistics 225 and one or more database interaction buttons 230. While any assortment of profile creation information may be included in the profile creation logistics 225, in one embodiment the individual (or group of individuals) who identified, reviewed and qualified/developed the attribute profile may be included (i.e., profile qualifier). In one embodiment, the database interaction buttons 230 may correspond to printing or emailing a given subtechnology profile, navigating through a sequence of subtechnology profiles, marking or highlighting profiles for later access, and so on.

However, the primary component of any subtechnology profile is the subtechnologies attributes. Subtechnology attributes are a predetermined collection of technology-based attributes, shown as attributes 235₁-235₆ in FIG. 2A, which are organized into one or more categories, shown as categories 220₁-220₆. In one embodiment, each category may be separately selectable by clicking on any one of the category tabs (i.e., tabs 220₁-220₆).

As will be described below, each category may have a number of associated attributes relating to the given subtechnology (i.e., subtechnology 215). Attributes, as a whole, may be described as a set of predetermined traits that, when defined, may encompass everything from the basic description of a subtechnology to the intricate channels through which the world affects it, and it affects the world. Each individual attribute may contain a clip of information that outlines or describes a particular facet of a technology's existence and function. This full collection of a technology's attributes may be referred to as a subtechnology profile. In one embodiment, the attributes may be the same regardless of the particular subtechnology being profiled. That is, the attributes may be constant across all subtechnologies in order to be able to uniformly compare subtechnologies.

It should be appreciated that while certain attributes and categories are illustrated with respect to FIGS. 2A-2H, these are only meant as examples and should not limit the scope of the invention.

Referring now to FIG. 2B, depicted is the GUI template 200 of FIG. 2A after the various attributes 235₁-235₆ have been populated with the appropriate information. In the embodiment of FIG. 2B, the synopsis tab 220₁ has been selected and the attributes associated therewith displayed. In particular, a description attribute 235₁ may be used to described the subtechnology's 215 general characteristics, features and properties. The variants attribute 235₂ may be used to describe any variations on the subtechnology 215, which in this case is RFID technology. The graphical illustration attribute 235₃ may be used to include representative visual information, the hindrances attribute 235₄ may be used to describe any known limitations on the subtechnology 215, the maturity attribute 235₅ may be used to provide an estimate on how far along we are in the expected life of the subtechnology 215, and known experts in the field may be identified in the experts attribute 235₆.

It has been found that simply making technological solutions achievable isn't quite enough unless they are connected with the relevant projects and personnel within a business or company. Thus, the organization-level demand for the subtechnology may similarly be included as a category of attributes in the subtechnologies profile. In short, the demand for a subtechnology may be a set of attributes with the ability to both link the internal demand for the underlying information with the external information itself. In certain embodiments, a quantitative comparison of a technology's general relevance with the internal relevance potential as it relates to a given company may be provided. To that end, FIG. 2C depicts an embodiment of another GUI 237₁ after the demand category tab 220₂ for the subtechnology 215 has been selected. As shown, a different set of attributes is associated with the demand category tab 220. In particular, an internal expert attribute 240₁ may be used to identify any experts within a given organization, while the development status attribute 240₂ may be used to identify specific projects within the organization which are using, testing or considering the subtechnology 215. In this fashion, a user may be able to quickly and conveniently identify the level of expertise in a given subtechnology within their own organization.

Referring now to FIG. 2D, one embodiment of another GUI 237₂ is depicted showing additional attributes 240₃-240₇ for the demand category tab 220₂. In one embodiment, these additional attributes 240₃-240₇ may be accessible by scrolling down or across the GUI 237₁ and GUI 237₂. In any event, GUI 237₂ may be populated with information relating to any internal or organization-level resources and/or studies (attribute 240₃), any recommendation or advice from the profile qualifier (attribute 240₄), any upcoming projects relating to the subtechnology 215 (attribute 240₅), guidance from the organization's technology board (attribute 240₆) or any patents filed or issued relating to the particular subtechnology 215 (attribute 240₇). Additionally, once a technology has been connected with an organization's relevant internal projects, as soon as new innovations emerge with the potential to modify or replace those technologies, the different project teams may be instantly notified without actively having to search for new innovations themselves.

FIG. 2E depicts one embodiment of another GUI 242 after the interconnectivities tab 220₃ for the subtechnology 215 has been selected. The set of attributes 245₁-240₆ associated with the interconnectivities tab 220₃ may relate to how the subtechnology 215 is related to one or more other subtechnologies. It has been recognized that one of the keys to progressive technology evolution stems from new innovations that either partially change or entirely replace currently deployed technology. This means that every technology, present or future, has the inherent capability to modify, be modified, replace or be replaced. This phenomenon is referred to herein as technology interconnectivity. To that end, technology interconnectivity may be captured as one or more subtechnology attributes organized under the interconnectivities tab 220₃.

As shown in FIG. 2E, the exemplary interconnectivity attributes include a technological characteristics attribute 245₁, which may be used to describe what the technology can achieve, the technologies physical characteristics, and affected components for particular applications. In addition, an effects attribute 245₂ may be used to describe confirmed physical, chemical and biological effects or combinations thereof on which the subtechnology may be based. In addition, a description of which technologies are supported or enabled by the given subtechnology 215 may be included (attribute 245₃), as well as what other technologies support or enable this subtechnology (attribute 245₅). Similarly, what technologies may be substituted by or for the given subtechnology 215 may be included in the profile (attributes 245₄ and 245₆, respectively).

While FIG. 2E depicts only the interconnectivities tab 220₃ as containing interconnectivity information, it should equally be appreciated that one or more of the other categories 220₁-220₆ may similarly include such interconnectivity-type attributes.

Referring now to FIG. 2F, depicted is one embodiment of a GUI 247 for the subtechnology profile relating to the RFID subtechnology 215 after the environmental factors tab 220₄ has been selected. In one embodiment, the environmental factors category of attributes may be used to catalog any external or surrounding issues which may impact the viability or acceptability of the given subtechnology, including any known political perspectives on the subtechnology (attribute 250₁), any potential hazards of using the subtechnology (attribute 250₂), potential business and economic risks (attributes 250₃ and 250₄, respectively), evolving business and economic opportunities (attributes 250₅ and 250₆, respectively), etc.

FIG. 2G depicts one embodiment of a GUI 252 for the subtechnology profile relating to the RFID subtechnology 215 after the innovation path tab 220₅ has been selected. In one embodiment, the innovation path category of attributes may be used to catalog the engineering or development patch of the subtechnology 215. By way of example, under the innovation patch category the subtechnology profile can be supplemented with information relating to the future potential goals made achievable by the deployment of the given subtechnology (attribute 255₁), any known prototype information (attribute 255₂), a description of any research findings, such as milestones, relating to the subtechnology 215 (attribute 255₃), known production capabilities (attribute 255₄) and market entry information, if any (attribute 255₅).

Finally, FIG. 2H depicts an embodiment of another GUI 257 for the subtechnology profile relating to the RFID subtechnology 215 once the market/applications tab 220₆ has been selected. In one embodiment, the market/applications category of attributes may be used to catalog known information for market potential (attribute 260₁), applications potential (attribute 260₂), existing applications (attribute 260₃) and visual examples thereof (attribute 260₄). Of course, as previously mentioned, FIGS. 2A-2H include exemplary attributes only, and are not meant to be limiting in any way.

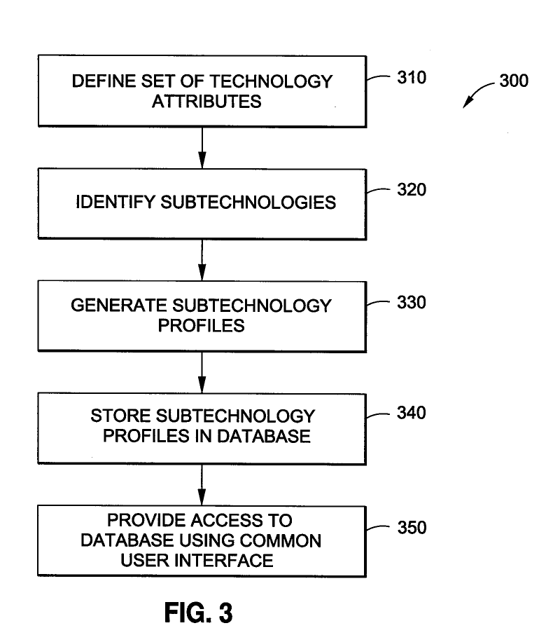

Referring now to FIG. 3, depicted is one embodiment of a process 300 for providing a common user interface to access to subtechnology profiles in a technology database. In particular, process 300 begins at block 310 where a predetermined set of technology attributes (e.g., attributes 235₁-235₆, attributes 240₁-240₇, attributes 245₁-245₆, attributes 250₁-250₆, etc.) may be defined. As previously described in detail, such technology attributes may correspond to set of predetermined traits that, when defined, may encompass everything from the basic description of a subtechnology to the intricate channels through which the world affects it, and it affects the world. Each individual attribute may contain a clip of information that outlines or describes a particular facet of a technology's existence and function. In one embodiment, the full collection of technology attributes defined at block 310 comprises a subtechnology profile. Moreover the defined set of attributes from block 310 may be consistent across all subtechnologies, thereby enabling the uniform comparison of all subtechnologies.

Process 300 may continue to block 320 where a plurality of subtechnologies may be identified. In one embodiment, each of the plurality of subtechologies may be defined or characterized by a common granularity level. As described above, a subtechnology (e.g., subtechnology 215) may have a granularity level between that of a technology family (e.g., technology family 210) and a physical effect (such as electroluminescence). It should further be appreciated that, in order to achieve the optimal technology granularity level, and hence properly identify a subtechnology, a systematic set of guidelines and refinement routines may be applied until either a suitable or optimal subtechnology profile is achieved, or the technological concept is deemed outside the optimal complexity level and thus not a proper subtechnology.

Once a plurality of subtechnologies has been properly identified above at block 320, process 300 may then continue to block 330 where a plurality of subtechnology profiles may be generated. In one embodiment, these subtechnology profiles may correspond to each of the above-identified plurality of subtechnologies, and may be generated based on the previously-defined set of technology attributes (block 310). While it should be appreciated that numerous approaches may be used, in one embodiment a GUI template (e.g., GUI template 200) may be used to enter the various technology attributes corresponding to each of the plurality of subtechnologies, thereby generating a plurality of subtechnology profiles. These subtechnology profiles may then be stored in a common technology database (e.g., database 110) at block 340. From there, a common user interface may be used to provide access to the database, and hence to the subtechnology profiles. In one embodiment, the common user interface may correspond to a GUI based on a template GUI, such as previously-described template GUI 200. In this fashion, an unlimited array of technologies may be researched, accessed and compared using a common structure and visual representation.

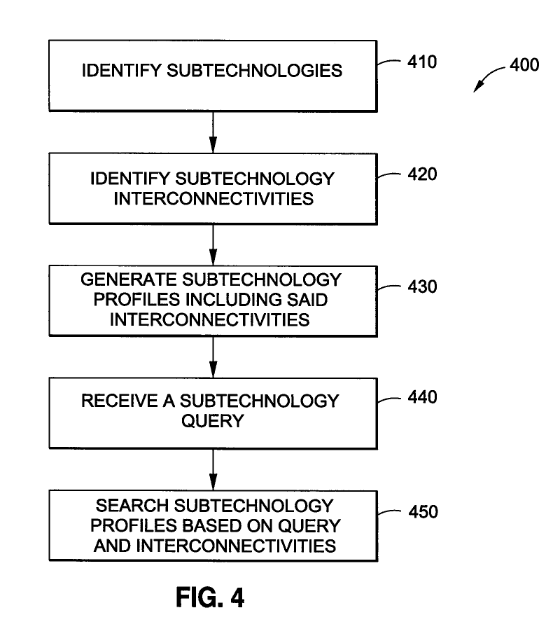

Referring now to FIG. 4, depicted is one embodiment of a process 400 for implementing a search functionality with respect to subtechnology profiles. In particular, process 400 begins at block 410 where a plurality of subtechnologies may be identified. In one embodiment, each of the plurality of subtechologies may be defined or characterized by a common granularity level. As described above, a subtechnology (e.g., subtechnology 215) may have a granularity level between that of a technology family (e.g., technology family 210) and a physical effect (such as electroluminescence). As with the embodiment described above with reference to FIG. 3, it should further be appreciated that, in order to achieve the optimal technology granularity level, and hence properly identify a subtechnology, a systematic set of guidelines and refinement routines may be applied until either a suitable or optimal subtechnology profile is achieved, or the technological concept is deemed outside the optimal complexity level and thus not a proper subtechnology.

Process 400 may then continue to block 420 where a plurality of subtechnology interconnectivities, relating to two or more of the identified plurality of subtechnologies, may correspondingly be identified. In one embodiment, the plurality of subtechnology interconnectivities may be represented by a set of subtechnology attributes (e.g., attributes 245₁-245₆) and may relate to how each of the plurality of subtechnologies may be related to one or more other subtechnologies.

In one embodiment, subtechnology interconnectivity may be characterized in the subtechnology's physical characteristics, the physical, chemical and biological effects or combinations thereof on which the subtechnology may be based, the technologies that are supported or enabled by the given subtechnology, the technologies that may be substituted by or for the given subtechnology, etc. As described above, one of the keys to progressive technology evolution stems from new innovations that either partially change or entirely replace currently deployed technology. That is, each and every technology has the inherent capability to modify, be modified, replace or be replaced by another technology. This technology interconnectivity may be identified and captured or represented as one or more subtechnology attributes at block 420.

Continuing to refer to FIG. 4, process 400 may then continue to block 430 where a plurality of subtechnology profiles may be generated, wherein the subtechnology profiles include the interconnectivites identified above at block 420. It should of course be appreciated that the subtechnology profiles generated at block 430 may further be based on a previously-defined set of technology attributes, which include one or more interconnectivity attributes. While it should be appreciated that numerous approaches may be used, in one embodiment a GUI template (e.g., GUI template 200) may be used to enter the various technology attributes corresponding to each of the plurality of subtechnologies, thereby generating a plurality of subtechnology profiles. These subtechnology profiles may then be stored in a common technology database (e.g., database 110), which may be accessible using a common user interface, such as the previously-described template GUI 200.

Process 400 may then continue to block 440 where a subtechnology query may be received. While in one embodiment, the query may be a Boolean keyword query, in another embodiment the query may be comprised of a technological subject, problem or desired solution.

Based on the received query of block 440, process 400 may then continue to block 450 where the previously-generated plurality of subtechnology profiles may be searched based on both the received query of block 440, as well as the identified interconnectivities of block 420. In this regard, it should be appreciated that the system and methodology disclosed herein may include at least two searching regimes—text searching and connectivity searching. While the text search may rely on a standard database keyword search, the connectivity search provides a much more meaningful function in that it compares one or more attributes of subtechnology records to return a results list of related subtechnologies, which may or may not themselves contain the various search terms. In one embodiment, the attributes that are compared may relate to the interconnectivity of two or more subtechnologies.

In one embodiment, the interconnectivity attributes described above may be used to identify a solution to an engineering problem which may not be otherwise apparent to the engineer. By way of example, suppose an innovation engineer seeks to enhance the brightness of headlights without changing energy consumption or heat output. One embodiment would return a list of results for, not only an existing relevant subtechnologies, but would also be able to present a view of the entire extent to which the subtechnology exists in the world. In short, this is the essence of the connectivity search—to semantically determine what type of information a query asks for, then through known interconnectivities and various attribute comparisons, present possible technology solutions, including a view of the part of the world in which the technology has relevance. It should be appreciated that, in addition to using interconnectivity attributes to present more meaningful search results, it should equally be appreciated that other subtechnology attributes may be similarly utilized, whether individually or together.

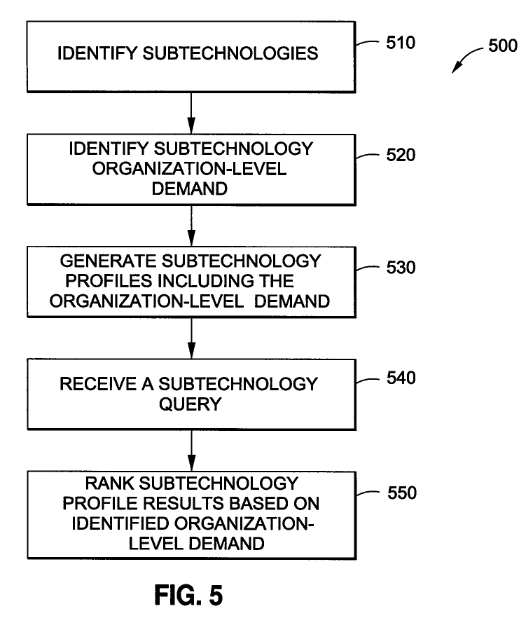

Referring now to FIG. 5, depicted is one embodiment of a process 500 for improving the usefulness and functionality of a subtechnology database, as disclosed herein. Process 500 begins at block 510 where, as with process 400, a plurality of subtechnologies may be identified. Again, each of the plurality of subtechologies may be defined or characterized by a common granularity level between that of a technology family and a physical effect.

It has been found that simply making technological solutions achievable isn't quite enough unless they are connected with the relevant projects and personnel within a business or company. To that end, process 500 may then continue to block 520 where the organization-level demand and/or expertise, for each of the identified plurality of subtechnologies, may correspondingly be identified. In one embodiment, this organization-level demand and/or expertise may be represented by a set of subtechnology attributes (e.g., attributes 240₁-240₇) and may provide the ability to both link the internal demand for the underlying information with the external information itself. In certain embodiments, a quantitative comparison of a technology's general relevance with the internal relevance potential as it relates to a given company or organization may be provided.

Continuing to refer to FIG. 5, process 500 may then continue to block 530 where a plurality of subtechnology profiles may be generated, wherein the subtechnology profiles include the organization-level demand attributes identified above at block 520. As described above, however, it should further be appreciated that the subtechnology profiles generated at block 530 may also include additional, predefined technology attributes. Moreover, as with the processes of FIGS. 3-4, a GUI template (e.g., GUI template 200) may be used to enter the various technology attributes corresponding to each of the plurality of subtechnologies, thereby generating a plurality of subtechnology profiles. These subtechnology profiles may then be stored in a common technology database (e.g., database 110), which may be accessible using a common user interface, such as the previously-described template GUI 200.

Process 500 may then continue to block 540 where a subtechnology query may be received. As with the process of FIG. 4, the received at block 540 may be a Boolean keyword query, in another embodiment the query may be comprised of a technological subject, problem or desired solution. Based on the received query of block 540, process 500 may then continue to block 550 where, following a search of the underlying technology database (e.g., database 110), a plurality of subtechnology search results may be ranked based on the identified organization-level demand information of block 520. In this fashion, the most relevant technologies, not only to a particular engineering discipline, but also to a particular organization, may be quickly identified. In other embodiments, the ranking of the subtechnology search results may be based, at least in part, on a quantitative comparison of the subtechnology's general relevance to the user, with the internal relevance to the user's company or organization.

In still another embodiment, once a subtechnology has been associated with a particular project, project members may be automatically alerted to any new innovations which have the potential to modify or replace the subject subtechnology.

It should further be appreciated that, with respect to each of the processes described above with reference to FIGS. 3-5, a semantic network (e.g., organization-level network 105 of FIG. 1) may utilize a special form of knowledge representation that in turn allows a system to not only deal with the transfer of information, but also designate a type to that information. The importance of this is related to the attribute structure described in detail above, whereby a certain type of information (e.g., the attribute title) is defined, followed by the information itself (e.g., the contents of the attribute). When used in conjunction with advanced searching algorithms, this methodology allows the determination of what type of information is relevant to a query (e.g., which attribute) then display or manipulate the information itself (e.g., the contents of the attribute). This is the basis behind semantically determining the relevance between an inputted query and the information in the technology database.

### Exemplary Embodiments of the Invention

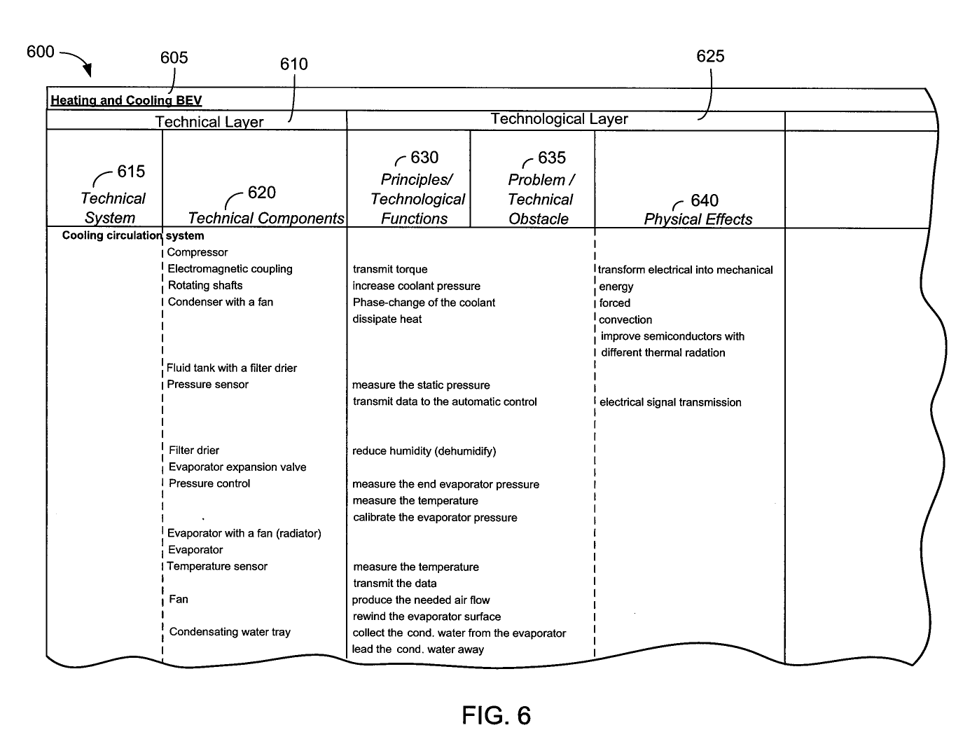

The present disclosure relates generally to the concept of systematically identifying technical solutions in a technology development environment. To that end, reference to FIGS. 6-10 will be made to illustrate the exemplary embodiments of a process for identifying technology-based solutions in the context of technical component development.

Referring first to FIG. 6, depicted is one embodiment of a technology development interface 600 configured in accordance with the principles of the invention. The technology development interface 600 may correspond to particular system development project or a component development project for a given organization. The technology development 600 may be accessed from and displayed on a user work station (e.g., work stations 120) coupled to an organization-level network (e.g., organization-level network 105). As with the GUI template 200 of FIGS. 2A-2H, the work stations may be configured to execute software which generates the technology development interface 600 and/or otherwise interfaces with one or more technology databases (e.g., database 110). It should of course be appreciated that the technology database may be a single database or a collection of individual databases. It should further be appreciated that numerous other network configurations would be consistent with the principles of the invention.

As part of a technology development effort, the technology development interface 600 may be used to systematically breakdown system-level technology to the technological level. To that end, technology development interface 600 may correspond to a particular field (or family) of technology, which in the embodiment of FIG. 6 is shown as field 605 (i.e., Heating and Cooling BEV). It should of course be appreciated that there will be many different fields that are a function of the underlying application (e.g., vehicle manufacturing, etc.). Within each field (i.e., field 605), a technology layer 610 is provided which is comprised of a plurality of technical systems 615. In turn, each of the plurality of technical systems 615 may be comprised of a plurality of technical components 620. In one embodiment, each technical system 615 is broken down into its various technical components 620 using a predefined set of criteria that may be applied uniformly across all technical systems 615, and even across different technology fields.

The technology development interface 600 further includes a technological layer 625 that includes one or more technological functions 630 associated with the corresponding technical components 620. In one embodiment, the technological functions 630 may correspond to the function performed or otherwise carried out by the various technical components 620 that comprise a particular technical system 615. For example, in the embodiment of FIG. 6 the technical system 615 is the “cooling circulation system,” which is comprised of a number of components, such as a compressor, electromagnetic coupling, rotating shafts, condenser with a fan, etc. Each of these components, in turn, has at least one technological function 630 (e.g., transmitting torque, increasing coolant pressure, dissipating heat, etc.).

Continuing to refer to FIG. 6, the technological layer 625 is depicted as also including one or more problems or technical obstacles (“obstacles 635”), corresponding to the various technological functions 630, that are otherwise associated with technical component development. While in one embodiment, the technical component development may correspond to the same technical components 620 that perform the various technological functions 630, in other embodiments the technical component development may correspond to a technical component that is not within the particular technical system 615 or even the field 605, but which may otherwise perform the same or similar identified function.

The technological layer 625 may further include corresponding physical effects 640 corresponding to the various technological functions 130. As described above, a physical effect describes the scientific mechanism or process behind the characteristic effects resulting from, or used as a basis for the normal operation of a technology (e.g., technical components 620) that allows it to fulfill a technological function (e.g., technological functions 630).

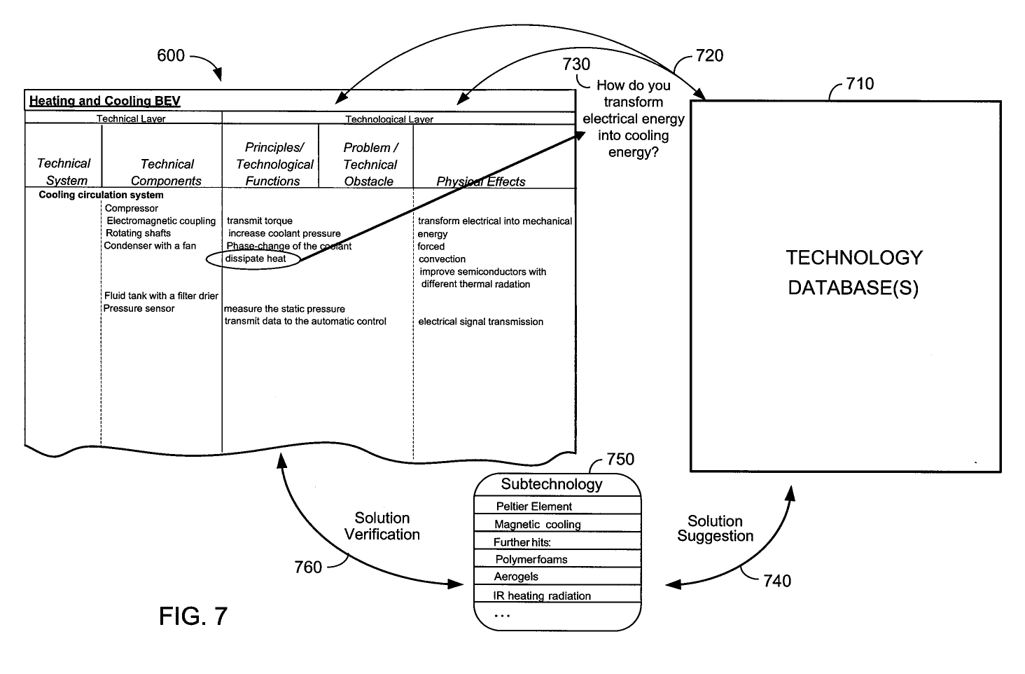

Referring now to FIG. 7, an embodiment of the technology development interface 600 of FIG. 6 is depicted as interacting with a technology database 710. While in one embodiment, the technology database 710 may be the subtechnology database 110 described in detail above, in other embodiments it may have a different organization and/or structure for storing information regarding various technical systems, corresponding technology components and corresponding technological functions. For example, the technology database 710 may correspond to a database containing technical information on previous technology development projects. In addition, while only one technology database 710 is shown in FIG. 7, it should equally be appreciated that the technology development interface 600 may interact with more than one technology database, either sequentially or simultaneously.

The interaction between the technology development interface 600 and the technology database 710 may involve various facets. For example, for a given technical component (e.g., compressor, etc.), the technology database 710 may be used to populate the corresponding technological functions (e.g., technological functions 130), perceived problems or obstacles (e.g., obstacles 135) and/or the corresponding physical effects (e.g., physical effects 140). In one embodiment, the process of using the technology database 710 to populate at least some portions of the technology development interface 600 may be based on passing component-based and/or functional-based keywords or queries to the technology database 710. In response, the technology database 710 may return relevant technological functions (e.g., technological functions 130), perceived problems or obstacles (e.g., obstacles 135) and/or the corresponding physical effects (e.g., physical effects 140). This interaction 720 may be a manual process initiated by the user or may be an automatic process based on underlying algorithms for searching the technology database 710.

Aside from the process of populating the technology development interface 600 using corresponding technological information from database 710, the interaction between the technology development interface 600 and database 710 may further include question-based querying for the purpose of identifying one or more potential solutions to an identified development obstacles. By way of example, question 730 may be posed to the database 710 as a search term by a user. The question 730 may alternatively be constructed from an underlying identified obstacle (e.g., obstacles 135). Regardless of how it is formed, once the question 730 has been posed, the technology database may generate one or more “hits,” or potential solutions 740. In certain embodiments, the solution generation process may be based on the principles outlined above with respect to identified subtechnology interconnectivities.

Once generated, the set of potential solutions 750 may be delivered to the technology development interface 600 in the form of a solution staging area, as will be described in more detail below. A solution verification 760 may also be performed, which in one embodiment may be a manual verification exercise. As the potential solution set is being generated by the software system itself using string comparison, the results may possess some degree of irrelevance to the stated problem. To that end, it may be desirable to manually verify which of the solutions are capable of solving the actual identified problem. In this, consideration of the boundary conditions accompanying the problem is required, which may be a task not easily performed by a software-based system.

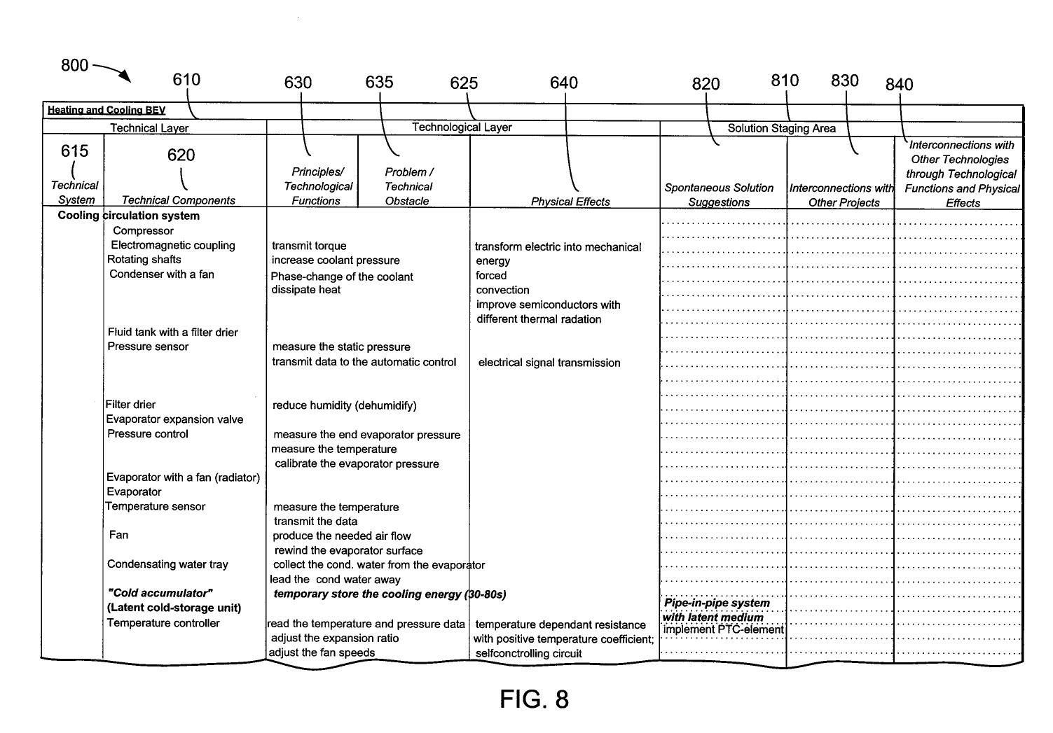

Referring now to FIG. 8, depicted is another embodiment of a technology development interface 800 configured in accordance with the principles of the invention. The technology development interface 800 of FIG. 8 includes the technical layer 610 and technological layer 625 described above with reference to FIG. 6. However, the technology development interface 800 is further configured with a solution staging area 810 that is comprised of three potential solutions sets—spontaneous solution suggestions 820, other project interconnections 830 and other technology interconnections 840. In one embodiment, the potential solution sets may correspond to identified problems or obstacles associated with technical component development (e.g., obstacles 635). While in one embodiment, the technical component development may correspond to a given technical component (e.g., technical components 620) that perform one or more technological functions (e.g., technological functions 630), in other embodiments the technical component development may correspond to a technical component that is not within the particular technical system, but which has been identified as being capable of performing the similar technological functions as a known component within the particular technical system.

With respect to the spontaneous solution suggestions 820 of FIG. 8, this section may contain potential solutions that generated during an ongoing discussion between experts, for example. Such solutions may be purely technical, purely technological or both. As such, such solutions may represent another interface to the technological database or, in other words, another source of terms that can be used as search strings by the user. As in the case of the other interfaces, the search process may be either a manual or at least partially automatic search process, depending on the software implementation.

With respect to other project interconnections 830, this section may be populated with solution-based information drawn from one or more previous technology development projects. While in one embodiment, the previous projects may correspond to development efforts engaged in by a single organization, in other embodiments organizations may equally be able to share technology development information. Moreover, in order to systematically identify relevant technology-based solutions, in a preferred embodiment the information relating to the previous projects may be stored in a format compatible to that of the technology development interface 800.

Finally, the technology development interface 800 includes a solution set for other technology interconnections 840. In certain embodiments, the solution set for other technology interconnections 840 may be populated with solution-based information drawn from a connected technology database, such as database 710. In this fashion, a complete technology development solution staging area may be provided to a user in a single interface. In one embodiment, the solutions based on technology interconnections 840 may be generated using a subtechnology query of a technology database (e.g., database 110), and searching a plurality of subtechnology profiles based on the subtechnology query.

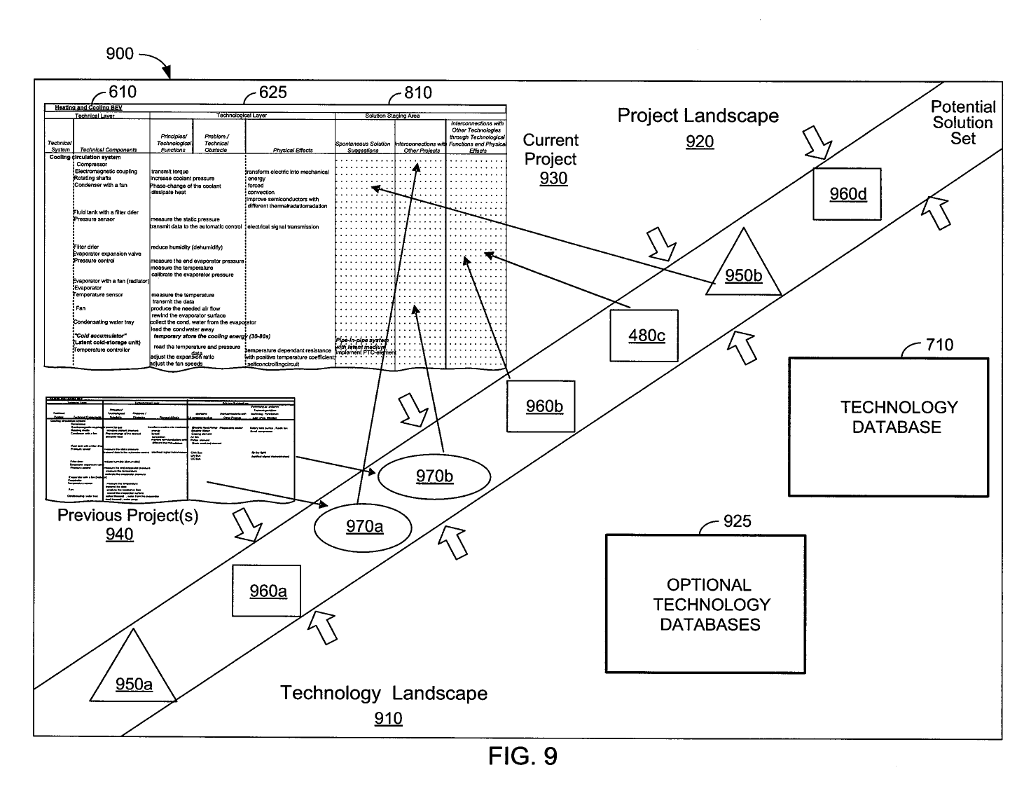

Referring now to FIG. 9, depicted is a block diagram of the technology development landscape 900, and in particular one embodiment for how the solution staging area 810 of the technology development interface 800 may be populated in accordance with the principles of the invention. In the depicted embodiment, the landscape is divided into the technology landscape 910 and the project landscape 920. The technology landscape 910 comprises the technology database 710 described in detail above, as well as various other optional technology databases 925. While one embodiment the technology database 710 may be the subtechnology database 110 described in detail above, in other embodiments the database 710 may have a different organization and/or structure for storing information regarding various technical systems, corresponding technology components and corresponding technological functions. The other optional technology databases 925 may similarly be any other form of technology-based databases (e.g., Google™, Wikipedia™, Engineering Village™, etc.).

Within the project landscape 920, the current project 930 consists of a user interface having the above-described technical layer 610, technology layer 625 and solution staging area 810. The project landscape 920 further includes previous projects 940.

Dividing the technology landscape 910 from the project landscape 920 is a potential solution set which includes spontaneous solutions 950a-950b (“950”), technology interconnection solutions 960a-960d (“960”) and previous project solutions 970a-970b (“970”).

As described above, the spontaneous solutions 950 may contain potential solutions that are generated during an ongoing discussion between experts, for example. As previously mentioned, such solutions may be purely technical, purely technological or both. Moreover, as with the solution suggestions 820 of FIG. 8, the spontaneous solutions may similarly server as another source of terms that can be used as search strings by the user, and in either a manual or at least partially automatic search process, depending on the software implementation.

Similarly, the technology interconnection solutions 960 may contain potential solutions identified from one or more connected technology database, such as technology database 710 and/or other optional technology databases 925. As previously described, the technology database 710 may be a configured as a common technology database (e.g., database 110) which stored a plurality of subtechnology profiles based on a previously-defined set of technology attributes, where the subtechnology profiles corresponding to subtechnologies have a common granularity level. Alternatively, the database 710 may have a different organization and/or structure for storing information regarding various technical systems.

It should be appreciated that the manner in which the technology interconnection solutions 960 may be identified in the technology database 710 and/or the optional databases 925 may vary. By way of example, in one embodiment the technology interconnection solutions 960 may be identified by passing component-based and/or functional-based keywords or queries to the technology database 710. This may be performed as a manual process initiated by the user or may be an automatic process based on underlying algorithms for searching the technology database 710.

With respect to the previous project solutions 970, previous technology development projects (i.e., previous projects 940) may yield potential solutions for the current project 930 as well. Such previous projects may correspond to technology development efforts engaged in by a single organization, or similarly by other organizations who share such information. In certain embodiments, the previous project solutions 970 may be provided in a format compatible to that of the solution staging area 810.

In this fashion, a set of potential solutions for one or more technology development obstacles may be compiled using spontaneous solutions 950, technology interconnection solutions 960 and previous project solutions 970. This complete set of potential solutions may then be used to populate the solution staging area 810, as shown in FIG. 9, which will then contain a comprehensive set of potential solutions that correspond to identified problems or obstacles associated with technical component development (e.g., obstacles 635). While in one embodiment, the technical component development may correspond to the development of a technical component (e.g., technical components 620) of a given technical system (e.g., technical system 615), in other embodiments the technical component development may correspond to technical component(s) that are not within a particular technical system, but which have been identified as being otherwise capable of performing the same or similar technological functions (e.g., technological functions 630).

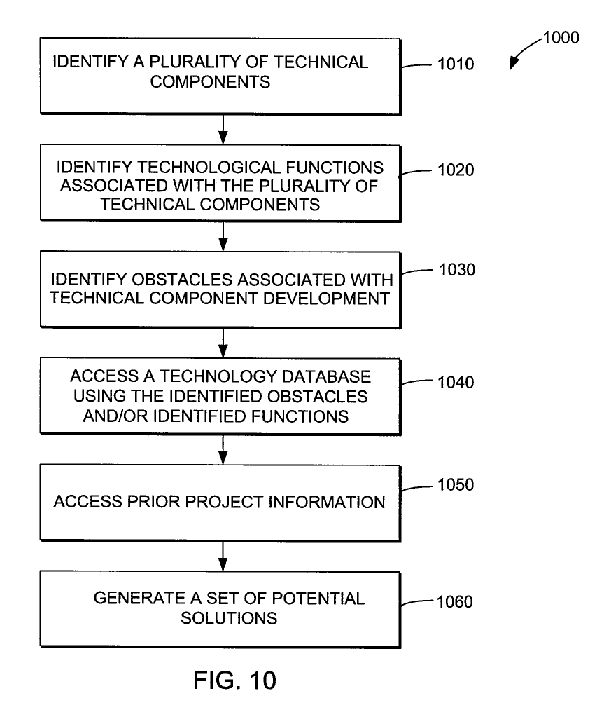

Referring now to FIG. 10, depicted is one embodiment of a process 1000 for identifying technology-based solutions in the context of technical component development. In particular, process 1000 begins at block 1010 where a plurality of technical components (e.g., technical components 620) may be identified for one or more particular technical systems (e.g., technical system 615). In one embodiment, the technical components defined at block 1010 may be identified by breaking down each given technical system into its various technical components using a predefined set of criteria that may be applied uniformly across all technical systems, and even across different technology fields.

Once the plurality of technical components have been identified, process 1000 may continue to block 1020 where the technological functions (e.g., technological functions 630) associated with the previously-defined technical components may be identified. In one embodiment, the technological functions may correspond to the function performed or otherwise carried out by the various technical components that comprise a particular technical system. The process of identifying technological functions may be accomplished, at least in part, by passing component-based and/or functional-based keywords or queries to a technology database (e.g., technology database 710). In response, the technology database may return relevant technological functions and/or the corresponding physical effects.

Process 1000 may continue to block 1030 where one or more obstacles associated with technical component development may be identified. In one embodiment, such obstacles may be identified using one or more of the identified technological functions from block 1020. In certain embodiments, the technical component development obstacles may be identified using component-based and/or functional-based keywords or queries to a technology database (e.g., technology database 710). Alternatively, the identified obstacles may be manually entered by one or more users via a user interface (e.g., technology development interface 600).

At this point, process 1000 may continue to block 1040 where a technology database may be accessed using one or both of the identified obstacles (block 1030) and identified technological functions (block 1020). While in one embodiment this technology database may be the subtechnology database 110 described in detail above, in other embodiments the technology database may have a different organization and/or structure for storing information regarding various technical systems, corresponding technology components and corresponding technological functions. Aside from the specific structure of the database, it may be accessed using the identified obstacles and/or identified technological functions using question-based or search-term-based querying.

Continuing to refer to FIG. 10, process 1000 further includes accessing prior project information (block 1050). In one embodiment, such prior project information may correspond to development efforts engaged in by a single organization, or by one or more other organizations that share technology development information. Such information may be stored in one or more databases, and may be stored in a standardized or common format.

At this point, process 1000 may continue to block 1060 where a set of potential solutions corresponding to the identified obstacles is generated. In one embodiment, this set of potential solutions may be based on the accessed prior project information and/or the information accessed from the technology database. The generated set of potential solutions may be comprised of spontaneous solutions (e.g., spontaneous solution suggestions 820), solutions based on interconnections with other projects (e.g., other project interconnections 830), and/or solutions based on interconnections with other technologies (e.g., other technology interconnections 840). In one embodiment, the set of potential solutions may be provided to a user in the form of a solution staging area (e.g., solution staging area 810) which may simultaneously display all three potential solutions sets—spontaneous solution suggestions, other project interconnections and other technology interconnections.

It should further be appreciated that the set of potential solutions may correspond to potential solutions for the development of a technical component of a given technical system or, alternatively, for the development of a technical component that is not within the particular technical system, but which has been identified as being capable of performing the similar technological functions as a known component within the particular technical system.

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for identifying technology-based solutions comprising the acts of:
identifying a plurality of technical components for each of a plurality of technical systems;
identifying technological functions associated with at least one of the plurality of technical components;
identifying, using at least in part the identified technological functions, obstacles associated with technical component development;
accessing a technology database using at least one of the identified obstacles and identified technological functions;
accessing prior project information; and
generating a set of potential solutions for said one or more obstacles based on the prior project information and information from the technology database.

2. The method of claim 1, further comprising displaying the plurality of technical components, technological functions and obstacles on a technology development graphical user interface.

3. The method of claim 1, wherein identifying the plurality of technical components comprises identifying the plurality of technical components by breaking down each of the plurality of technical systems using a predefined set of criteria.

4. The method of claim 1, wherein identifying technological functions associated with at least one of the plurality of technical components comprises querying the technology database using at least one of component-based and functional-based keywords.

5. The method of claim 1, wherein accessing the technology database comprising accessing a plurality of technology profiles from the technology database using at least one of the identified obstacles and identified technological functions.

6. The method of claim 1, wherein accessing prior project information comprises accessing prior project information corresponding to at least one of the identified obstacles and identified technological function.

7. The method of claim 1, further comprising storing, in the technology database, a plurality of subtechnology profiles corresponding to each of a plurality of subtechnologies characterized by a common granularity level.

8. The method of claim 1, wherein generating the set of potential solutions comprises generating a solution staging area of a graphical user interface comprising the set of potential solutions.

9. The method of claim 8, wherein the set of potential solutions comprises spontaneous solutions, solutions based on interconnections with other projects and solutions based on interconnections with other technologies.

10. The method of claim 1, wherein generating the set of potential solutions comprises generating the set of potential solutions for the one or more obstacles based on the prior project information, if available, and on available information from the technology database.

11. A computer program product comprising:
a computer readable medium having computer executable program code embodied therein to identify technology-based solutions, the computer executable program product having:
computer executable program code to identify a plurality of technical components for each of a plurality of technical systems,
computer executable program code to identify technological functions associated with at least one of the plurality of technical components,
computer executable program code to identify, using at least in part the identified technological functions, obstacles associated with technical component development,
computer executable program code to access a technology database using at least one of the identified obstacles and identified technological functions,
computer executable program code to access prior project information, and
computer executable program code to generate a set of potential solutions for said one or more obstacles based on the prior project information and information from the technology database.

12. The computer executable program product of claim 11, further comprising computer executable program code to display the plurality of technical components, technological functions and obstacles on a technology development graphical user interface.

13. The computer executable program product of claim 11, wherein said computer executable program code to identify the plurality of technical components comprises computer executable program code to identify the plurality of technical components by breaking down each of the plurality of technical systems using a predefined set of criteria.

14. The computer executable program product of claim 11, wherein said computer executable program code to identify technological functions associated with at least one of the plurality of technical components comprises computer executable program code to query the technology database using at least one of component-based and functional-based keywords.

15. The computer executable program product of claim 11, wherein said computer executable program code to access the technology database comprising computer executable program code to access a plurality of technology profiles from the technology database using at least one of the identified obstacles and identified technological functions.

16. The computer executable program product of claim 11, wherein said computer executable program code to access prior project information comprises computer executable program code to access prior project information corresponding to at least one of the identified obstacles and identified technological function.

17. The computer executable program product of claim 11, further comprising computer executable program code to store, in the technology database, a plurality of subtechnology profiles corresponding to each of a plurality of subtechnologies characterized by a common granularity level.

18. The computer executable program product of claim 11, wherein the computer executable program code to generate the set of potential solutions comprises computer executable program code to generate a solution staging area of a graphical user interface comprising the set of potential solutions.

19. The computer executable program product of claim 18, wherein the set of potential solutions comprises spontaneous solutions, solutions based on interconnections with other projects and solutions based on interconnections with other technologies.

20. The computer executable program product of claim 11, wherein the computer executable program code to generate the set of potential solutions comprises computer executable program code to generate the set of potential solutions for the one or more obstacles based on the prior project information, if available, and on available information from the technology database.
